(19) United States
(12) Patent Application Publication
(10) Pub. No.: US 2024/0428292 A1
(43) Pub. Date: Dec. 26, 2024

(54) SYSTEMS AND METHODS FOR SELECTING MEDIA CONTENT USING DATA COLLECTED BY AN ELECTRIC VEHICLE CHARGING STATION

(71) Applicant: Volta Charging, LLC, San Francisco, CA (US)

(72) Inventors: Michael Rodger CLEMENT, Monterey, CA (US); Anant SHAH, San Ramon, CA (US); Bradford Thomas CRIST, San Francisco, CA (US)

(21) Appl. No.: 18/817,050

(22) Filed: Aug. 27, 2024

Related U.S. Application Data
(63) Continuation of application No. PCT/US2023/062927, filed on Feb. 21, 2023.
(60) Provisional application No. 63/315,205, filed on Mar. 1, 2022.

(51) Int. Cl. G06Q 30/0251; B60L 53/31; G06Q 30/0273; G06Q 50/06; G06Q 50/40

(52) U.S. Cl. CPC G06Q 30/0251; B60L 53/31; G06Q 30/0273; G06Q 50/06; G06Q 50/40; B60L 2250/16

(57) ABSTRACT

A server system receives, from a plurality of content providers, including a first content provider and a second content provider, a set of values, each value corresponding to satisfaction of one or more conditions that apply to a state of an electric vehicle charging station (EVCS). The server system receives, from the EVCS, data collected by one or more sensors of the EVCS and determines, using the data, a first state of the EVCS during a first time frame, the first state satisfying a first condition for the first content provider and a second condition for the second content provider. The server system selects, based on values received for the respective conditions that are met by the first state of the EVCS, the first content provider and provides media content associated with the first content provider for display.

### RELATED APPLICATIONS

This application is a continuation of PCT Application No. PCT/US2023/062927, filed Feb. 23, 2023, entitled “Systems and Methods for Selecting Media Content Using Data Collected by an Electric Vehicle Charging Station,” which claims priority to U.S. Provisional Application No. 63/315,205, filed Mar. 1, 2022, entitled “Systems and Methods for Selecting Media Content Using Data Collected by an Electric Vehicle Charging Station,” each of which is incorporated by reference in its entirety.

### TECHNICAL FIELD

This application relates generally to electric vehicle charging stations and, more particularly, to selecting media content using data collected by an electric vehicle charging station.

### BACKGROUND

Electric vehicles (EVs) are growing in popularity, largely due to their reduced environmental impact and lack of reliance on fossil fuels. As the number of EVs increases, there will be a corresponding need to expand supporting infrastructure, and in particular, a need for vastly more electric vehicle charging stations (EVCSs). Moreover, because EVCSs can be placed, e.g., in parking lots and on the street, the availability of electric vehicle charging stations will play an increasingly significant role in driver's decisions about where to travel.

Because of their prominent locations (e.g., parking lots of retail outlets), EVCSs provide an opportunity to display media content to both EVCS users and passersby. Viewer interactions with EVCSs are often fleeting, however, thus increasing the importance of selecting and providing relevant media content.

### SUMMARY

The disclosed implementations provide improved systems and methods of selecting media content to be displayed at an EVCS. In particular, the systems (e.g., server systems and client devices) and methods described herein account for environmental conditions present at the EVCS in selecting media content to be displayed at an in selecting media content to be displayed at an EVCS.

One way to select content for display at an EVCS is to rotate through predefined sets of media items (e.g., for a certain time period), including providing content that is most lucrative (e.g., displaying content for the highest bidder). Further, some systems attempt to target individuals based on demographic data for the user. Unfortunately, merely selecting media content according to a predefined schedule or by targeting certain demographics fails to consider how the media content providers might assign more or less value to media content based on a combination of environmental conditions that are detected, in real-time, at the EVCS. For example, a media content provider may place more value on an advertisement for umbrellas in rainy conditions than on a sunny day. Conventional methods of selecting media content for display at an EVCS fail to account for such factors.

To that end, in accordance with some implementations, a server system comprising one or more processors and memory, is provided. The server system is in communication with an electric vehicle charging station (EVCS). The memory stores instructions executable by the one or more processors for receiving, from a plurality of content providers, including a first content provider and a second content provider, a set of values, each value in the set of values corresponding to satisfaction of one or more conditions that apply to a state of an electric vehicle charging station (EVCS). The memory stores instructions for receiving, from the EVCS, data collected by one or more sensors of the EVCS and determining, using the data collected by the one or more sensors of the EVCS, a first state of the EVCS during a first time frame, the first state satisfying a first condition for the first content provider and a second condition for the second content provider, of the one or more conditions. The memory further stores instructions for identifying the first content provider and the second content provider as having values that correspond to satisfaction of respective conditions that are met by the first state of the EVCS. The memory further stores instructions for selecting, based on values received for the respective conditions that are met by the first state of the EVCS, the first content provider and providing media content associated with the first content provider for display.

Some implementations of the present disclosure provide a method that is performed by the server system.

Some implementations of the present disclosure provide a computer program product (e.g., a non-transitory computer readable storage medium storing instructions) that, when executed by a computer system having one or more processors, cause the computer system to perform any of the methods described herein.

### BRIEF DESCRIPTION OF THE DRAWINGS

For a better understanding of the various described implementations, reference should be made to the Detailed Description below, in conjunction with the following drawings in which like reference numerals refer to corresponding parts throughout the figures.

FIG. 1 illustrates a system for charging an electric vehicle in accordance with some implementations.

FIGS. 2A-2C illustrate a charging station for an electric vehicle in accordance with some implementations.

FIG. 3 is a block diagram of a server system in accordance with some implementations.

FIG. 4 is a block diagram of a charging station for an electric vehicle in accordance with some implementations.

FIG. 5 is a block diagram of a user device in accordance with some implementations.

FIG. 6 is a block diagram illustrating an example of selecting content based on sensor data from an EVCS, in accordance with some implementations.

FIG. 7 illustrates a flowchart of a method of selecting content based on sensor data from an EVCS, in accordance with some implementations.

FIGS. 8A-8C illustrate a flowchart of a method for providing content using data provided by an EVCS, in accordance with some implementations.

### DETAILED DESCRIPTION

Reference will now be made in detail to implementations, examples of which are illustrated in the accompanying drawings. In the following detailed description, numerous specific details are set forth in order to provide a thorough understanding of the various described implementations. However, it will be apparent to one of ordinary skill in the art that the various described implementations may be practiced without these specific details. In other instances, well-known methods, procedures, components, circuits, and networks have not been described in detail so as not to unnecessarily obscure aspects of the implementations.

Many modifications and variations of this disclosure can be made without departing from its spirit and scope, as will be apparent to those skilled in the art. The specific implementations described herein are offered by way of example only, and the disclosure is to be limited only by the terms of the appended claims, along with the full scope of equivalents to which such claims are entitled.

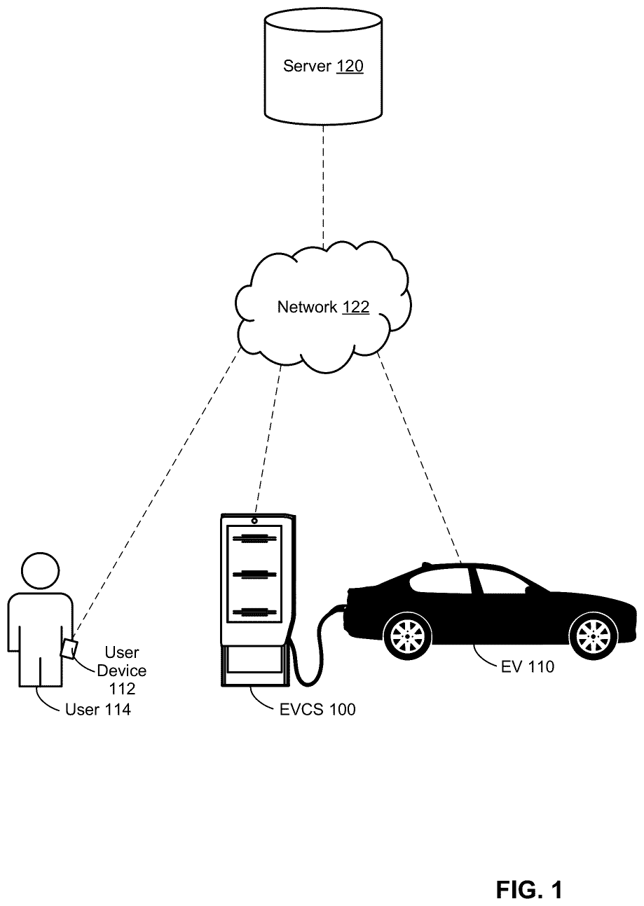

FIG. 1 illustrates an electric vehicle charging station (EVCS) 100 that is configured to provide an electric charge to an electric vehicle 110 via one or more electrical connections. In some implementations, the EVCS 100 provides an electric charge to electric vehicle 110 via a wired connection, such as a charging cable. Alternatively, the EVCS 100 may provide an electric charge to electric vehicle 110 via a wireless connection (e.g., wireless charging). In some implementations, the EVCS 100 may be in communication with the electric vehicle 110 or a user device 112 belonging to a user 114 (e.g., a driver, passenger, owner, renter, or other operator of the electric vehicle 110) that is associated with the electric vehicle 110. In some implementations, the EVCS 100 communicates with one or more devices or computer systems, such as user device 112 or server system 120, respectively, via a network 122.

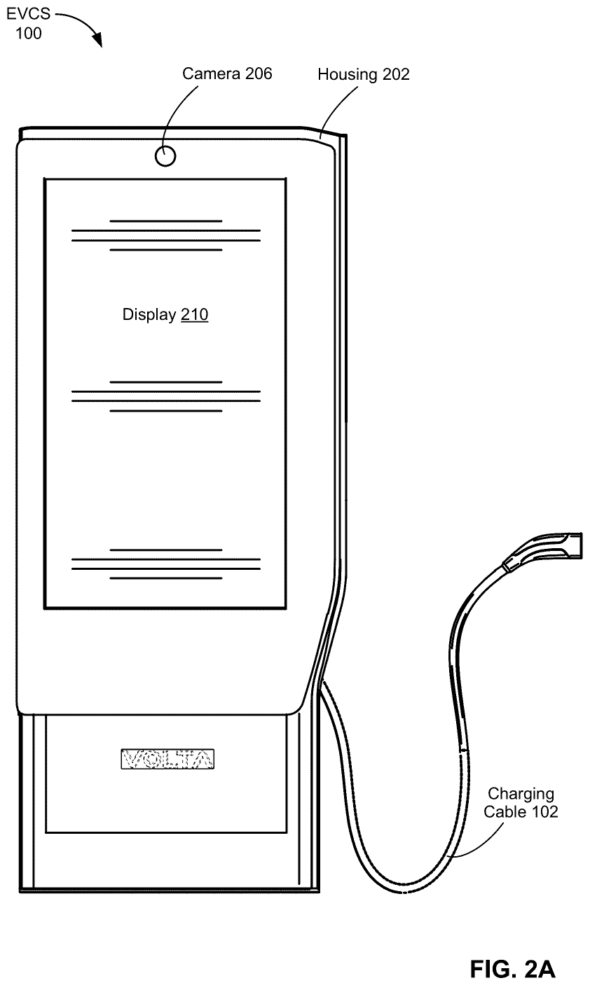

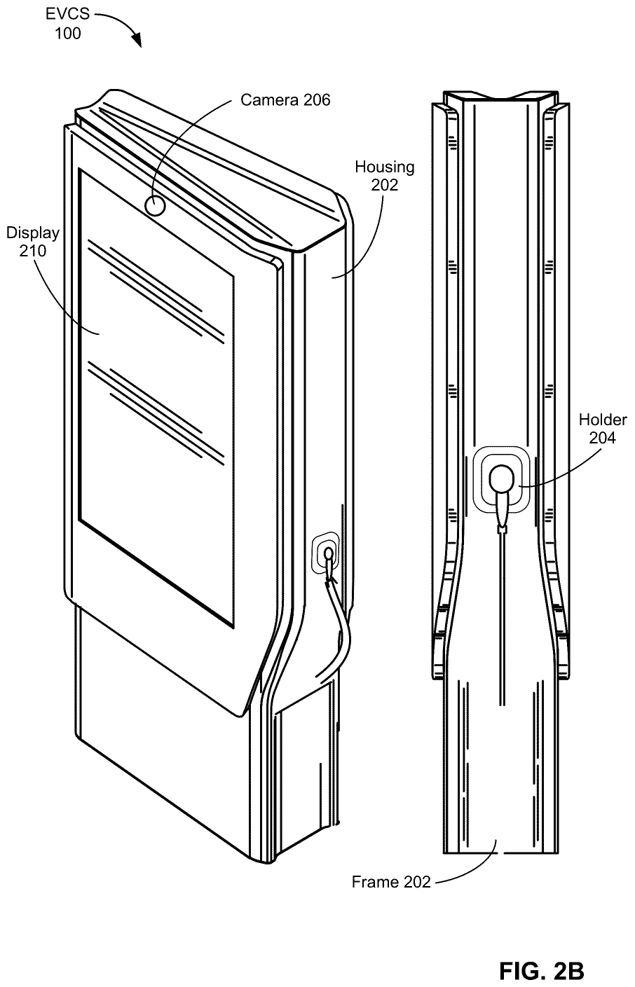

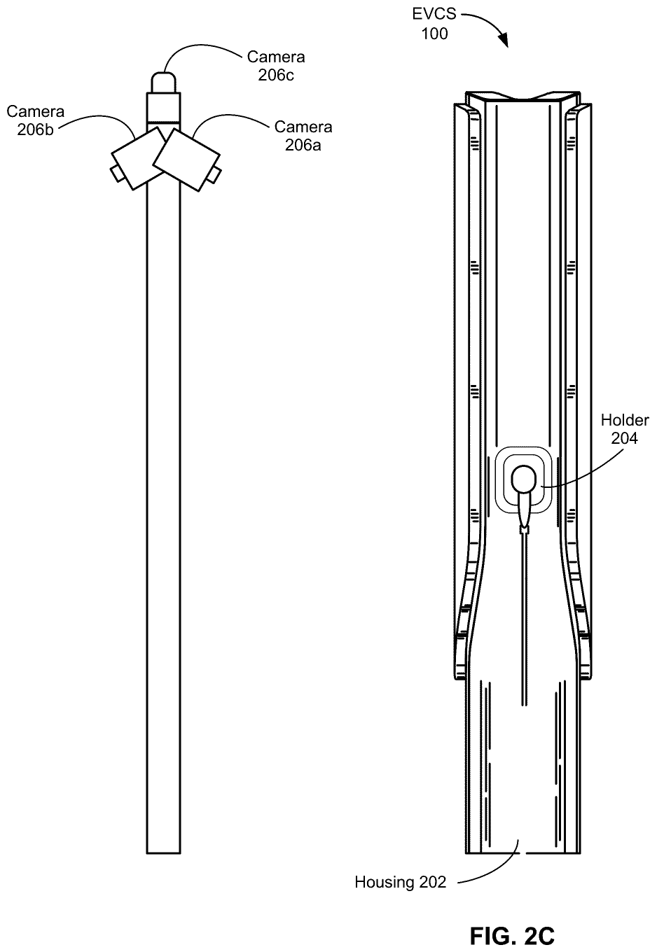

FIG. 2A is a mechanical drawing showing various views of an electric vehicle charging station (EVCS) 100, in accordance with some implementations. FIG. 2B is a mechanical drawing showing additional views of the EVCS 100 of FIG. 2A, in accordance with some implementations. FIG. 2C shows an alternative configuration of EVCS 100, in accordance with some implementations. FIGS. 2A-2C are discussed together below.

EVCS 100 includes a housing 202 (e.g., a body or a chassis) including a charging cable 102 (e.g., connector) configured to connect and provide a charge to an electric vehicle 110 (FIG. 1). An example of a suitable connector is an IEC 62196 type-2 connector or a CCS (“Combined Charging System”) standard connector (e.g., CCS1, CCS2). In some implementations, the connector is a “gun-type” connector (e.g., a charge gun) that, when not in use, sits in a holder 204 (e.g., a holster). In some implementations, the housing 202 houses circuitry for charging an electric vehicle 110. For example, in some implementations, the housing 202 includes power supply circuitry as well as circuitry for determining a state of a vehicle being charged (e.g., whether the vehicle is connected via the connector, whether the vehicle is charging, whether the vehicle is done charging, etc.).

The EVCS 100 further includes one or more displays 210 facing outwardly from a surface of the EVCS 100. For example, the EVCS 100 may include two displays 210, one on each side of the EVCS 100, each display 210 facing outwardly from the EVCS 100. In some implementations, the one or more displays 210 display messages (e.g., media content) to users of the charging station (e.g., operators of the electric vehicle) and/or to passersby that are in proximity to the EVCS 100. In some implementations, each of the displays 210 are on a respective panel that has a height that is at least 60% of a height of the housing 202 and a width that is at least 90% of a width of the housing 202. In some implementations, the panel 102 has a height that is at least 3 feet and a width that is at least 2 feet.

In some implementations, the EVCS 100 includes one or more panels that hold a display 210. The displays are large compared to the housing 202 (e.g., 60% or more of the height of the frame and 80% or more of the width of the frame), allowing the displays 210 to function as billboards, capable of conveying information to passersby. In some implementations, the displays 210 are incorporated into articulating panels that articulate away from the housing 202 (e.g., a sub-frame). The articulating panels solve the technical problem of the need for maintenance of the displays 210 (as well as one or more computers that control content displayed on the display). To that end, the articulating panels provide easy access to the entire back of the displays 210. In addition, in some implementations, the remaining space between the articulating panels (e.g., within the housing 202) is hollow, allowing for ample airflow and cooling of the displays 210.

The EVCS 100 further includes a computer that includes one or more processors and memory. The memory stores instructions for displaying content on the display 210. In some implementations, the computer is disposed inside the housing 202. In some implementations, the computer is mounted on a panel that connects (e.g., mounts) a first display (e.g., a display 210) to the housing 202. In some implementations, the computer includes a near-field communication (NFC) system that is configured to interact with a user's device (e.g., user device 112 of a user 114 of the EVCS 100).

In some implementations, the EVCS 100 includes one or more sensors (not shown) for detecting data in a region (area) proximal to the housing. For example, the area proximal to the EVCS 100 includes one or more parking spaces, where an electric vehicle 110 parks in order to use the EVCS 100. In some implementations, the area proximal to the EVCS 100 includes walking paths (e.g., sidewalks) next to the EVCS 100. In some implementations, the one or more sensors are configured to determine a state of the area proximal to the EVCS 100 (e.g., determine conditions present at the charging station). The one or more sensors can detect stationary or moving external objects. The one or more sensors of the EVCS 100 include one or more image (e.g., optical) sensors (e.g., one or more cameras 206), ultrasound sensors, depth sensors, infrared (IR), red-green-blue (RGB) cameras, passive infrared (PIR), heat IR, proximity sensors, radar, audio sensors (e.g., microphone) and/or tension sensors. The one or more sensors may be connected to the EVCS 100 or a computer system associated with the EVCS 100 via wired or wireless connections such as via a Wi-Fi connection or Bluetooth connection.

In some implementations, the housing 202 includes one or more lights configured to provide predetermined illumination patterns indicating a status of the EVCS 100. In some implementations, at least one of the one or more lights is configured to illuminate an area proximal to the EVCS 100 as a person approaches the area (e.g., a driver returning to a vehicle or a passenger exiting a vehicle that is parked in a parking spot associated with the EVCS 100).

In some implementations, the housing 202 includes one or more cameras 206 configured to capture one or more images of an area proximal to the EVCS 100. In some implementations, the one or more cameras 206 are configured to obtain video of an area proximal to the EVCS 100. For example, a camera may be configured to obtain a video or capture images of an area corresponding to a parking spot associated with the EVCS 100. In another example, another camera may be configured to obtain a video or capture images of an area corresponding to a parking spot next to the parking spot of the EVCS 100. In a third example, the camera 206 may be a wide angle camera or a 360° camera that is configured to obtain a video or capture images of a large area proximal to the EVCS 100, including a parking spot of the EVCS 100. As shown in FIG. 2B, the one or more cameras 206 may be mounted directly on a housing 202 of the EVCS 100 and may have a physical (e.g., electrical, wired) connection to the EVCS 100 or a computer system associated with the EVCS 100. Alternatively, as shown in FIG. 2C, the one or more cameras 206 (or other sensors) may be disposed separately from but proximal to the housing 202 of the EVCS 100 (e.g., cameras 206a-206c are disposed on a post or pedestal adjacent to the EVCS 100). In some implementations, the camera 206 may be positioned at different locations on the EVCS 100 than what is shown in the figures. Further, in some implementations, the one or more cameras 206 include a plurality of cameras positioned at different locations on the EVCS 100.

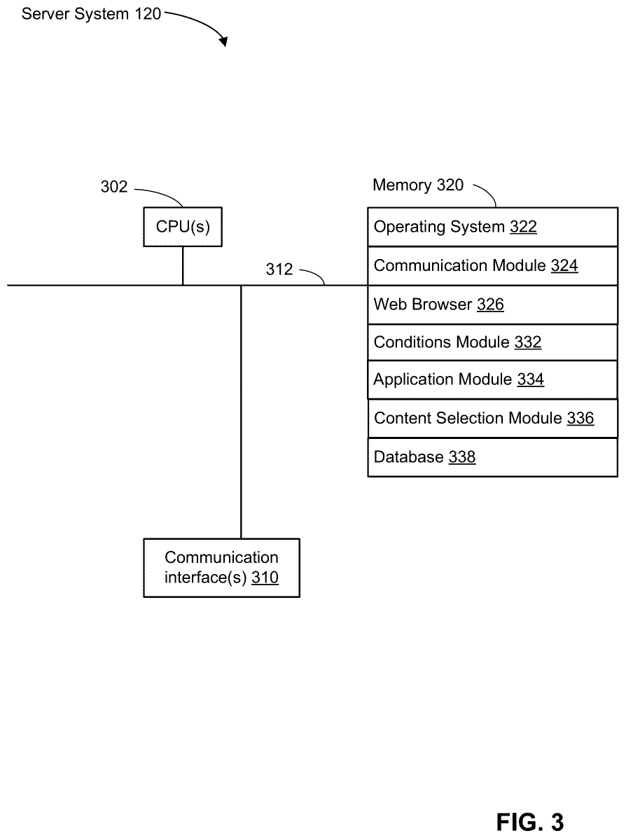

FIG. 3 is a block diagram of a server system 120, in accordance with some implementations. Server system 120 may include one or more computer systems (e.g., computing devices), such as a desktop computer, a laptop computer, and a tablet computer. In some implementations, the server system 120 is a data server that hosts one or more databases (e.g., databases of images or videos), models, or modules or may provide various executable applications or modules. The server system 120 includes one or more processing units (processors or cores, CPU(s)) 302, one or more network or other communications network interfaces 310, memory 320, and one or more communication buses 312 for interconnecting these components. The communication buses 312 optionally include circuitry (sometimes called a chipset) that interconnects and controls communications between system components.

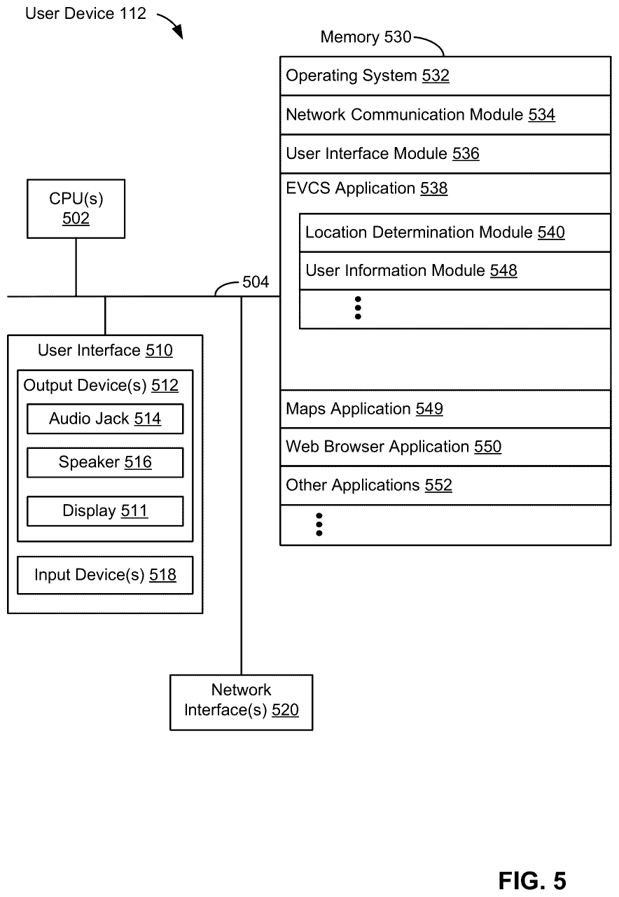

The memory 320 includes high-speed random-access memory, such as DRAM, SRAM, DDR RAM, or other random-access solid-state memory devices; and may include non-volatile memory, such as one or more magnetic disk storage devices, optical disk storage devices, flash memory devices, or other non-volatile solid-state storage devices. In some implementations, the memory 320 includes one or more storage devices remotely located from the one or more processing units 302. The memory 320, or alternatively the non-volatile memory devices within the memory 320, includes a non-transitory computer-readable storage medium. In some implementations, the memory 320 or the computer-readable storage medium of the memory 320 stores the following programs, modules, and data structures, or a subset or superset thereof:
an operating system 322, which includes procedures for handling various basic system services and for performing hardware dependent tasks;
a communications module 324, which is used for connecting the server system 120 to other computers and devices via the one or more communication network interfaces 310 (wired or wireless), such as the internet, other wide area networks, local area networks, metropolitan area networks, and so on;
a web browser 326 (or other application capable of displaying web pages), which enables a user to communicate over a network with remote computers or devices;
a conditions module 332 for determining, based on data collected by sensors of the EVCS 100, one or more conditions that are satisfied based on a current state of the EVCS (e.g., current environmental conditions detected for the EVCS);
an application module 334 for providing services to EVCS mobile application 538 (FIG. 5), including responding to requests for available charging stations, and transmitting content items (e.g., from database 338) to EVCS mobile application 538 for display of the content items at the user device 112;
a content selection module 336 for determining (e.g., based on the one or more conditions) which content items and/or content providers to provide (e.g., from database 338) for display; and
database 338 for storing content items and metadata associated with the content items, including an identifier of a content provider of the content item, one or more values and associated conditions for the content item, and/or other metadata related to the content item.

Each of the above identified executable modules, applications, or sets of procedures may be stored in one or more of the previously mentioned memory devices and corresponds to a set of instructions for performing a function described above. The above identified modules or programs (i.e., sets of instructions) need not be implemented as separate software programs, procedures, or modules, and thus various subsets of these modules may be combined or otherwise re-arranged in various implementations. In some implementations, the memory 320 stores a subset of the modules and data structures identified above. Furthermore, the memory 320 may store additional modules or data structures not described above.

Although FIG. 3 shows a server system 120, FIG. 3 is intended more as a functional description of the various features that may be present rather than as a structural schematic of the implementations described herein. In practice, and as recognized by those of ordinary skill in the art, items shown separately could be combined and some items could be separated.

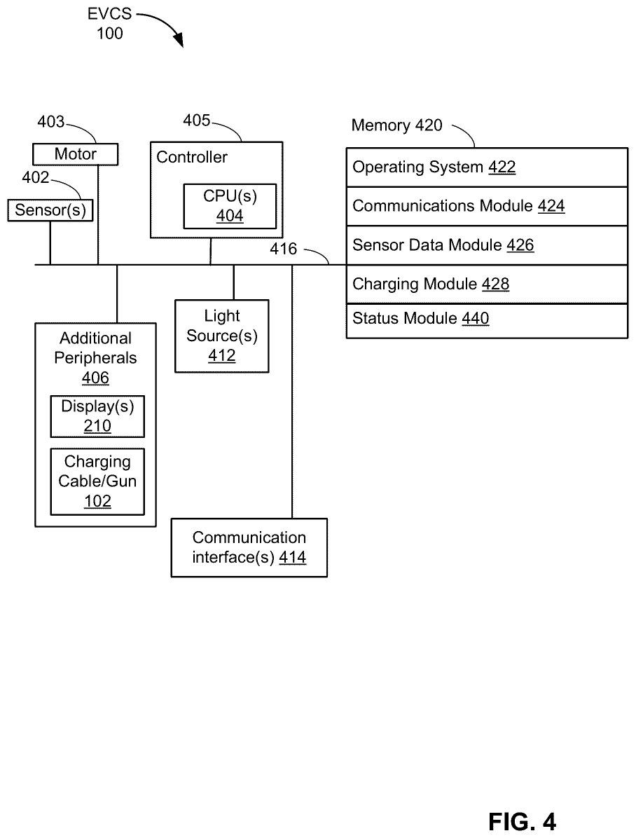

FIG. 4 is a block diagram of an EVCS 100 (FIGS. 1 and 2A-2C) for charging an electric vehicle, in accordance with some implementations. The EVCS 100 optionally includes a motor 403 (configured to retract a portion of a charging cable), a controller 405 that includes one or more processing units (processors or cores) 404, one or more network or other communications network interfaces 414, memory 420, one or more light sources 412, one or more sensors 402, additional peripherals 406, and one or more communication buses 416 for interconnecting these components. The communication buses 416 optionally include circuitry (sometimes called a chipset) that interconnects and controls communications between system components. In some implementations, the memory 420 stores instructions for performing (by the one or more processing units 404) a set of operations, including determining a status of the EVCS 100, wherein the status indicates a state of an electric vehicle 110 at the charging station.

EVCS 100 typically includes additional peripherals 406 such as displays 210 for displaying content, and charging cable 102. In some implementations, the displays 210 may be touch-sensitive displays that are configured to detect various swipe gestures (e.g., continuous gestures in vertical and/or horizontal directions) and/or other gestures (e.g., a single or double tap) or to detect user input via a soft keyboard that is displayed when keyboard entry is needed.

The user interface may also include one or more sensors 402 such as cameras (e.g., camera 206, described above with respect to FIGS. 2A-2B), ultrasound sensors, depth sensors, infrared cameras, visible (e.g., RGB or black and white) cameras, passive infrared sensors, heat detectors, infrared sensors, proximity sensors, radar, or audio sensors (e.g., microphones). In some implementations, the one or more sensors 402 are for detecting weather conditions (e.g., environmental conditions) in a region proximal to the housing and/or the status of the EVCS 100 (e.g., available, occupied, etc.) in order to perform various operations, such as retracting the charging cable safely and/or selecting content for display.

The memory 420 includes high-speed random-access memory, such as DRAM, SRAM, DDR RAM, or other random-access solid-state memory devices; and may include non-volatile memory, such as one or more magnetic disk storage devices, optical disk storage devices, flash memory devices, or other non-volatile solid-state storage devices. In some implementations, the memory 420 includes one or more storage devices remotely located from the processing units 404, such as database 338 of server system 120 that is in communication with the EVCS 100. The memory 420, or alternatively the non-volatile memory devices within the memory 420, includes a non-transitory computer-readable storage medium. In some implementations, the memory 420 or the computer-readable storage medium of the memory 420 stores the following programs, modules, and data structures, or a subset or superset thereof:
an operating system 422, which includes procedures for handling various basic system services and for performing hardware dependent tasks;
a communications module 424, which is used for connecting the EVCS 100 to other computers and devices via the one or more communication network interfaces 414 (wired or wireless), such as the internet, other wide area networks, local area networks, metropolitan area networks, and so on;
a sensor data module 426 for collecting data from the one or more sensors of EVCS 100 and transmitting the data to server system 120;
a charging module 428 for charging an electric vehicle (e.g., measuring how much charge has been delivered to an electric vehicle, commencing charging, ceasing charging, etc.);
a status module 440 for monitoring a charging status of the EVCS 100 (e.g., a status of the EVCS 100 with respect to charging of an electric vehicle or its ability/inability to charge an electric vehicle).

In some implementations, the memory 420 stores metrics, thresholds, and other criteria, which are compared against the measurements captured by the one or more sensors 402. For example, data obtained from a PIR sensor of the one or more sensors 402 can be compared with baseline data to detect that an object is in proximity the EVCS 100.

Each of the above identified executable modules, applications, or sets of procedures may be stored in one or more of the previously mentioned memory devices and corresponds to a set of instructions for performing a function described above. The above identified modules or programs (i.e., sets of instructions) need not be implemented as separate software programs, procedures, or modules, and thus various subsets of these modules may be combined or otherwise re-arranged in various implementations. In some implementations, the memory 420 stores a subset of the modules and data structures identified above. Furthermore, the memory 420 may store additional modules or data structures not described above.

Although FIG. 4 shows an EVCS 100, FIG. 4 is intended more as a functional description of the various features that may be present rather than as a structural schematic of the implementations described herein. In practice, and as recognized by those of ordinary skill in the art, items shown separately could be combined and some items could be separated.

FIG. 5 is a block diagram of a user device 112 of a user 114 in accordance with some implementations. In some implementations, the user 114 is associated with (e.g., an operator of) an electric vehicle 110 at EVCS 100. Various examples of the computing device 112 include a cellular-capable smart device such as a smartphone, a smart watch, a laptop computer, a tablet computer, and other computing devices that have a processor capable of connecting to the EVCS 100 via a communications network (e.g., network 122), or receiving a beacon signal from an EVCS 100.

The user device 112 typically includes one or more processing units (processors or cores) 502, one or more network or other communications network interfaces 520, memory 530, and one or more communication buses 504 for interconnecting these components. The communication buses 504 optionally include circuitry (sometimes called a chipset) that interconnects and controls communications between system components. The user device 112 typically includes a user interface 510. The user interface 510 typically includes one or more output devices 512 such as an audio output device 514, such as speakers 516 or an audio output connection (e.g., audio jack) for connecting to speakers, earphones, or headphones. The user interface 510 also typically includes a display 511 (e.g., a screen or monitor). In some implementations, the user device 112 includes input devices 518 such as a keyboard, mouse, and/or other input buttons. Alternatively or in addition, in some implementations, the user device 112 includes a touch-sensitive surface. In some embodiments, the touch-sensitive surface is combined with the display 511, in which case the display 511 is a touch-sensitive display. In some implementations, the touch-sensitive surface is configured to detect various swipe gestures (e.g., continuous gestures in vertical and/or horizontal directions) and/or other gestures (e.g., single/double tap). In computing devices that have a touch-sensitive surface (e.g., a touch-sensitive display), a physical keyboard is optional (e.g., a soft keyboard may be displayed when keyboard entry is needed). Furthermore, user device 112 may also include a microphone and voice recognition software to supplement or replace the keyboard.

The memory 530 includes high-speed random-access memory, such as DRAM, SRAM, DDR RAM, or other random-access solid-state memory devices; and may include non-volatile memory, such as one or more magnetic disk storage devices, optical disk storage devices, flash memory devices, or other non-volatile solid-state storage devices. In some implementations, the memory 530 includes one or more storage devices remotely located from the processing units 502. The memory 530, or alternatively the non-volatile memory devices within the memory 530, includes a non-transitory computer-readable storage medium. In some implementations, the memory 530 or the computer-readable storage medium of the memory 530 stores the following programs, modules, and data structures, or a subset or superset thereof:
an operating system 532, which includes procedures for handling various basic system services and for performing hardware dependent tasks;
a network communication module 534, which is used for connecting the user device 112 to other computers and devices via the one or more communication network interfaces 520 (wired or wireless), such as the internet, other wide area networks, local area networks, metropolitan area networks, and so on;
a user interface module 536 for providing user interfaces for the user to interact with the user device 112 via applications on the user device 112 and the operating system 532 of the user device 112;
an EVCS mobile application 538 for communicating with an EVCS 100 or a server system that supports the EVCS 100. In some embodiments, EVCS mobile application 538 is capable of determining a current location of the user device 112 (using a location determination module 540). In some embodiments, location determination module 540 uses a global navigation satellite system (GNSS) such as the global positioning system (GPS), Galileo, BeiDou, or GLONASS;
user information module 548 for transmitting a user identifier associated with user device 112 to server system 120;
a maps application 549 for determining a location of the user device 112, including determining a proximity of the user device 112 with electric vehicle charging stations;
a web browser application 550 for accessing the internet and accessing websites on the internet, including providing functionalities on the EVCS mobile application 538 via a website accessed through web browser application 550; and
other applications 552 that the user 114 may have installed on the user device 112 or that may have been included as default applications on the user device 112.

Each of the above identified executable modules, applications, or sets of procedures may be stored in one or more of the previously mentioned memory devices and corresponds to a set of instructions for performing a function described above. The above identified modules or programs (i.e., sets of instructions) need not be implemented as separate software programs, procedures, or modules, and thus various subsets of these modules may be combined or otherwise re-arranged in various implementations. In some implementations, the memory 530 stores a subset of the modules and data structures identified above. Furthermore, the memory 530 may store additional modules or data structures not described above.

Although FIG. 5 shows a user device 112, FIG. 5 is intended more as a functional description of the various features that may be present rather than as a structural schematic of the implementations described herein. In practice, and as recognized by those of ordinary skill in the art, items shown separately could be combined and some items could be separated.

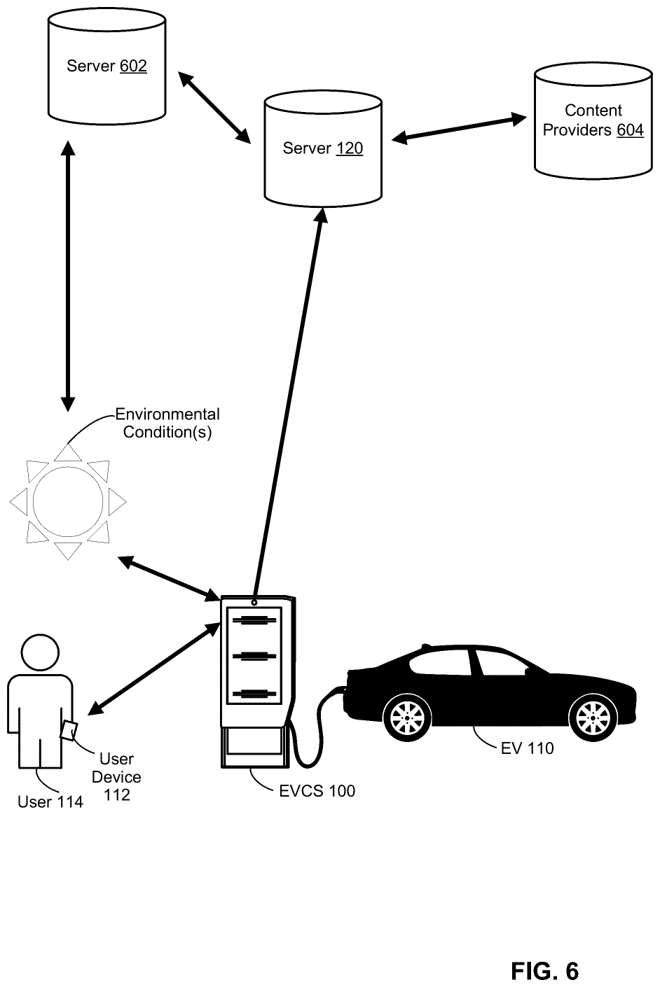

FIG. 6 is a block diagram illustrating an example scenario in which data collected by sensors at an EVCS 100 is sent to a server 120 for selecting content to provide to EVCS 100 and/or to user 114, in accordance with some implementations (FIG. 6 is not drawn to scale).

As illustrated, in some embodiments, a user 114 may park their electric vehicle 110 in a bay of EVCS 100, where EVCS 100 is configured to provide an electric charge to electric vehicle 110 via one or more electrical connections. In some embodiments, an electric vehicle is not currently parked in the bay of the EVCS 100 (e.g., content is selected to provide the EVCS 100 whether or not the EVCS is currently being used to charge an electric vehicle). It will be understood that content is provided (e.g., to EVCS 100) whether or not an EV 110 is currently parked in the bay of the EVCS 100.

In some embodiments, EVCS 100 includes one or more sensors. For example, EVCS 100 includes one or more image (e.g., optical) sensors (e.g., one or more cameras 206), ultrasound sensors, depth sensors, infrared (IR), red-green-blue (RGB) cameras, passive infrared (PIR), heat IR, proximity sensors, radar, temperature sensors, humidity sensors, tension sensors, and/or audio sensors (e.g., microphones). In some embodiments, data collected by the one or more sensors of EVCS 100 are transmitted to server 120, wherein the data indicate a state of the EVCS 100.

In some embodiments, the data transmitted to server 120 include indications of one or more environmental conditions that are currently present at the EVCS 100. For example, one or more sensors of the EVCS determine if it is sunny, cloudy, and/or raining, and the EVCS transmits an indication of the current weather to server 120. In some embodiments, the one or more sensors do not make a determination of the weather, and instead the EVCS 100 sends raw data collected by the one or more sensors to server 120 (e.g., wherein server 120 makes a determination of the weather in accordance with the received raw data).

Examples of states of the EVCS 100 that may be indicated by the data collected by the one or more sensors include: weather data (e.g., temperature, rain, snow, sun, clouds, etc.), demographic data for individuals near the EVCS 100 (e.g., demographic data for user 114 and/or another individual detected near the EVCS 100), data collected from one or more user devices (e.g., user device 112) within a predefined proximity of the EVCS 100, and/or other data indicating a (e.g., current) state of the EVCS 100. In some embodiments, the state of the EVCS 100 is determined in real-time at server 120 in accordance with data that is transmitted from EVCS 100 to server 120. In some embodiments, data collected by the one or more sensors are pushed to server 120 periodically (e.g., every 30 seconds, every 5 minutes, every day, etc.). In some embodiments, data collected by the one or more sensors are pushed to server 120 in response to detection of an event (e.g., in response to detecting a change in weather (e.g., temperature, rain, etc.), in response to detecting motion, in response to detecting one or more sounds, in response to detecting that a vehicle has connected to the EVCS to charge, and/or in response to detecting one or more individuals being within proximity of the EVCS 100). It will be understood that alternative and/or additional events may trigger EVCS 100 to transmit data collected by the one or more sensors to server 120.

In some embodiments, EVCS 100 is in communication with a plurality of other EVCSs in a network of EVCSs. For example, the network of EVCSs includes EVCSs positioned at different locations (e.g., outside of a predefined proximity) and/or EVCSs that are co-located (e.g., within a predefined proximity, such as 10 feet) with each other. In some embodiments, one or more sensors of a first EVCS in the network of EVCSs transmits data to server 120, and server 120 selects content to provide to a second EVCS, distinct from the first EVCS, in the network based on the sensor data collected by the first EVCS. As such, the server 120 is enabled to combine data received from other EVCSs in a network, and to select content to provide based on the combined data. For example, if the first and second EVCSs are co-located, the server 120 is enabled to use weather data collected from the first EVCS to determine the state of the second EVCS (e.g., without receiving weather data collected by the second EVCS). In some embodiments, this sharing of data reduces the amount of bandwidth required to send data from the EVCSs to server 120.

In some embodiments, server 120 also receives information from one or more third-party servers 602. For example, server 602 is associated with a third-party that collects environmental data at a location associated with EVCS 100. For example, the third-party server 602 provides information related to a date, time, and/or weather at a location corresponding to EVCS 100. As such, the data collected by the one or more sensors may be, in some embodiments, supplemented with additional information received from third-party servers 602.

In some embodiments, a plurality of content providers 604 provide server 120 with content items (e.g., to be displayed by EVCS 100 and/or at user device 112) and indications of values, for each content item, related to the possible states of EVCS 100. For example, a first content provider assigns a first value (e.g., a monetary value, or a bid) to a first content item (e.g., provided by the first content provider) in accordance with a first condition being met (e.g., if the temperature is above 80 degrees), and assigns a second value to the first content item in accordance with the first condition not being met (e.g., if the temperature is not above 80 degrees). Although the above is an example of a content provider assigning two values to a respective content item based upon satisfaction or dissatisfaction of a condition, it will be understood that content providers can provide multiple values for a respective content item (e.g., a value assigned between temperatures of 0-65, a value assigned between temperatures of 65-80, a value assigned to a temperature of 80 or greater, etc.). Further, in some embodiments, the content provider provides different sets of values in accordance with other (e.g., additional or alternative) conditions being met (e.g., if it is sunny at the EVCS, if it is a particular day of the week, if it is a particular holiday, etc.). As such, content providers assign a range of values to the content items provided by the content providers to reflect the importance of providing those content items when an EVCS is in a particular state (e.g., when one or more conditions are satisfied by the EVCS).

In some embodiments, server 120 collects values from each content provider of the plurality of content providers 604, and stores the values. In some embodiments, one or more content providers of the plurality of content providers 604 provide sets of values to server 120 that are not associated with particular content items. For example, a content provider assigns a value to selecting any of the content provided by the content provider (e.g., and/or assigns a value for performing another action on behalf of the content provider) in accordance with satisfaction of one or more conditions. For example, instead of server 120 selecting a content item based on the values assigned to the respective content items (e.g., and determining the content provider associated with the selected content item), the server 120 selects a content provider based on values assigned to the content providers overall.

In some embodiments, one or more of the content providers assigns a value their content being provided as a threshold percentage of the overall content for the EVCS 100 (e.g., or for a plurality of EVCSs in a network of EVCSs, including EVCS 100). For example, a content provider assigns a greater value to having content provided to the EVCS at least 25% of the time, and a lesser if less than 25% of the total content (e.g., displayed at EVCS 100) is provided by the content provider (e.g., the content provider will pay a first price per advertisement if their content is not displayed at least 25% of the time, and a second, higher, price per advertisement if their content is displayed at least 25% of the time). As such, a content provider is enabled to assign value to having an overall presence (e.g., an amount of content provided) at an EVCS.

In some embodiments, the server 120 selects content to provide based on a combination of the values described above. For example, the server 120 considers values assigned to particular content items (e.g., each associated with a particular content provider), values assigned to content providers as a whole (e.g., an umbrella company assigns a high value to any of its content if the condition of rain is satisfied), and values assigned to selecting a certain content provider for a certain percentage of the total content to be provided at EVCS 100.

In some embodiments, server 120 uses the data collected by the one or more sensors of the EVCS (e.g., and/or other EVCSs in the network) and, optionally, the data obtained from third-party server 602 to determine a current state of the EVCS 100. For example, server 120 determines a current time of day, day of the week, ambient temperature, weather pattern (e.g., sunny, raining, snowing, etc.), number of individuals nearby, demographic information related to individuals nearby, etc. relative to the EVCS 100.

In some embodiments, server 120 uses the data to determine whether one or more conditions (e.g., as defined by the content providers) are satisfied. In some embodiments, more than one condition is satisfied concurrently (e.g., it is a Saturday with a temperature of 90 degrees). In some embodiments, server 120 determines which content providers have assigned a greatest value to satisfaction of the current condition(s) of the EVCS. For example, based on the values assigned by the content providers, server 120 determines which content to provide.

In some embodiments, the server 120 selects a content provider that has assigned the greatest value under the current conditions (e.g., for the current state of the EVCS). In some embodiments, the server 120 selects the content provider before selecting a particular content item (e.g., the content item having the highest value assigned to the content item for the content provider). In some embodiments, the server 120 selects the particular content item, and selects the content provider associated with the particular content item. In some embodiments, in response to a content provider being selected (e.g., in accordance with having a greatest value assigned), a determined value for the selected content provider (e.g., amount charged to the selected content provider) is not the greatest value that was assigned by the first content provider. For example, if a first content provider assigns a value of $0.80 for a first condition, and a second content provider assigns a value of $0.70 for the first condition (or a second condition that is also satisfied by the current state of the EVCS), the first content provider is selected because $0.80 is greater than $0.70, but because the next-highest bid was $0.70 (e.g., assigned by the second content provider), the first content provider is only charged $0.71 (e.g., one cent more than the next-highest bid). As such, the value charged to the selected content provider may be distinct from the value assigned by the content provider (e.g., the content provider is willing to bid “up to” $0.80, but need only be charged one increment more than the next-highest bid).

In some embodiments, the server 120 selects a content item associated with a content provider in accordance with certain content providers being selected for percentage of the content displayed (e.g., also referred to herein as “share of voice”). For example, a first content provider in aggregate is selected for 50% of the total time content is displayed (e.g., on an hourly, daily, weekly, or annual basis). In some embodiments, instead of always selecting a content provider that is the “highest bidder” (e.g., is willing to assign the greatest values to content under various conditions), server 120 maintains a level of fairness in selecting content providers such that even the content providers that assign the lowest values to content are selected.

In some embodiments, the server 120 selects a content item based on a combination of (i) the respective values assigned by the content providers to the current condition(s) that are satisfied at the EVCS and (ii) based on which content providers have already been selected to display content. For example, as described above, in some embodiments, content providers assign a value to being selected at least a threshold percentage of the total amount of content provided to the EVCS. As such, the server 120 determines whether selecting a respective content provider would satisfy the threshold percentage (e.g., and thus the respective content provider is willing to, for example, pay an additional fee to be selected (e.g., at least 25% of the time)).

In some embodiments, the server 120 further provides the content providers with options to modify the values assigned to content items. For example, a content provider is given an option to dynamically update a value assigned to a respective content item in accordance with the current state of the EVCS (e.g., to out-bid another content provider under certain conditions). In some embodiments, the values provided by the content providers represent maximum values (e.g., a maximum bid), wherein the content provider requests a dynamic value that is based on values assigned by other content providers (e.g., such that the content provider puts a value on a content item in order to out-bid another content provider). In some embodiments, the dynamic value is not to exceed the initial maximum value provided (e.g., the content provider is willing to place a value up to the maximum value for a given content item).

In some embodiments, content providers may be enabled to participate in flexible bidding, such that the content provider may change the values assigned to their content based on the actual conditions and/or actual content that has been selected within a previous time window (e.g., within the previous hour, day, week, month, etc.). For example, a first content provider would like both to achieve a minimum “share of voice” (e.g., an overall percentage of time their content is shown) and also to minimize their costs. In some embodiments, the first content provider initially assigns a lower value (e.g., provides a lower bid) to the current environmental conditions that doesn't always “win” (e.g., another content provider is often selected because they have assigned a higher value to the current conditions) to minimize cost to the first content provider. However, the first content provider is willing to increase the value to a higher value if the first content provider's share of voice is underperforming (e.g., the content provider will increase a respective value if they have not been selected at all within the past day). In this case, the first content provider can wait to know the outcome of the first auction round (e.g., and/or additional historical auction outcomes) and use that along with their achieved share of voice within the previous time window, to determine a “bump” to their bid to increase the chances of winning in a subsequent round. As such, the decision of the first content provider to bump the value assigned depends on the outcome of the previous auction round(s).

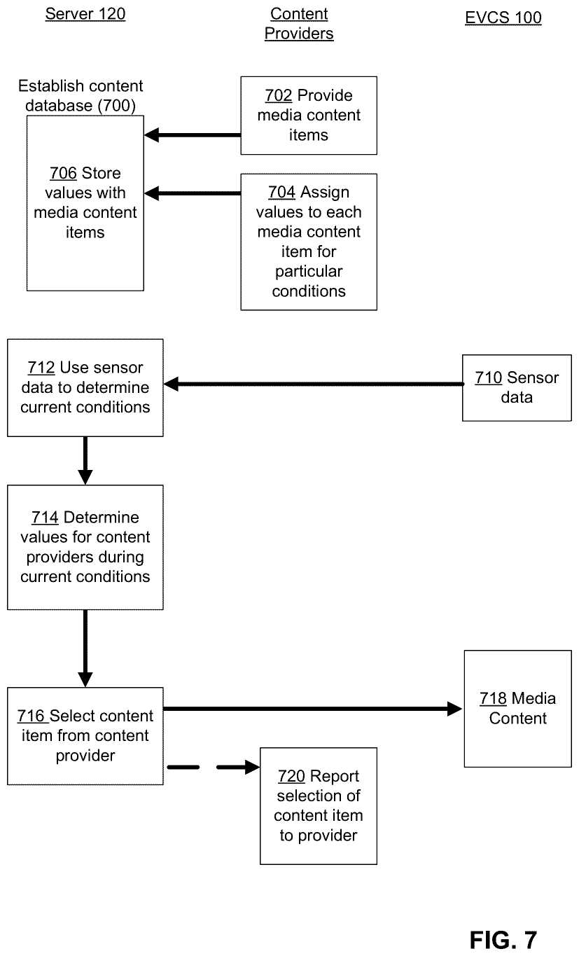

FIG. 7 illustrates a flowchart of a method of selecting media content to provide to an EVCS, as described with reference to FIG. 6. In some embodiments, content providers provide (702) a plurality of media content items to server 120, wherein server 120 establishes (700) a content database by storing the media content items. In some embodiments, the content database stores metadata (e.g., including a URL) for the media content items but not the media content themselves. In such embodiments, the media content items are typically served by a content distribution network (CDN). In some embodiments, the server 120 does not store information identifying any particular media content items, but stores information about various content provider's media campaigns.

In some embodiments, content providers also assign (704) values to each of the media content items provided to server 12 (e.g., or assigns values to the content provider itself for particular conditions, which is an example of the above-mention information for a particular media campaign). As described above, a first media content item may be assigned a plurality of values by a first content provider, each value in the plurality of values corresponding to satisfaction of one or more conditions determined for the EVCS 100. For example, a first media content item is assigned a first value if the condition “temperature is above 85 degrees” is satisfied, and assigned a second value if the condition “weather is sunny” is satisfied. In some embodiments, a plurality of conditions are satisfied concurrently (e.g., it is 85 degrees and sunny). In some embodiments, in accordance with a plurality of conditions being satisfied, the values related to each of the conditions are combined, for example, using a weighted combination. In some embodiments, the content provider assigns a third value for when multiple conditions are satisfied (e.g., a third value, distinct from the first and second values, is assigned to the first media content item if the conditions: temperature is above 85 degrees and weather is sunny, are satisfied). Accordingly, the content provider is enabled to assign different values to be used under various conditions and combinations of conditions and/or the server 120 is enabled to generate a value if multiple conditions are met by combining the values provided by the content providers for the individual conditions.

In some embodiments, the server 120 provides the content providers with selectable options for conditions (e.g., a set of predefined states) (e.g., based on conditions that can be detected by the sensors of the EVCS 100). For example, based on the types of data accessed by server 120, the state of the EVCS 100 is determined as a current state from a set of predefined states.

In some embodiments, the content providers assign values (704) to particular content items (e.g., or to the content provider itself) based on a relevance of the content item (e.g., or content item provider) to the current state of the EV. For example, a content item that includes an umbrella may be valued highly if the current state of the EV satisfies the condition of “weather is raining.” Similarly, if the content provider is an umbrella company, the content provider may provide an overall value to any content of the umbrella company (e.g., instead of different values to different content items).

In some embodiments, the server 120 stores (706) the values assigned to media items, and the condition(s) associated with each value, in the content database.

In some embodiments, the server 120 receives sensor data (710) collected at EVCS 100. For example, as described above, the server 120 receives data regarding the ambient temperature at the EVCS 100 (e.g., as detected by a temperature sensor at EVCS 100), weather data, and/or data about individuals detected near the EVCS 100 (e.g., as detected by one or more cameras).

In some embodiments, the server 120 uses the received sensor data to determine (712) a current state of the EVCS 100, and determines whether the current state of the EVCS 100 satisfies one or more conditions (e.g., of the conditions associated with the media content items in the content database). In some embodiments, the conditions are specified by the content providers.

In some embodiments, the server 120 determines (714) values for content providers during the current conditions. For example, the server 120 determines the content providers that have assigned the greatest values to content under the current conditions. For example, the server 120 determines which content providers have assigned the greatest values to particular content items under the current conditions and/or determines which content providers have assigned values to being selected for at least a threshold percentage of content (e.g., which content providers have assigned value to being selected at least 25% of the time, and the percentage of times those content providers have been selected thus far within a respective time period). In some embodiments, the server 120 considers both the values assigned to content items under the current conditions and the values assigned to overall selection of content for the content provider to determine which content provider to select.

In some embodiments, the server 120 selects (716) a content item from the identified content provider based at least in part on the determined current conditions.

Note that different content providers may provide values for different conditions, which could be met concurrently. For example, a first content provider could assign a first value to displaying the first content provider's media content item when the temperature is above 85 degrees, and a second content provider could assign a second value to displaying the second content provider's media item on a Saturday (or when a particular make of electric vehicle is parked in EVCS's stall). The server 120 would then select a media content item from at least the first content provider's media content item and the second content provider's media content item using the first and second values.

For example, a first content provider assigns a first value to a first condition and a second content provider assigns a second value to a second condition (e.g., distinct from and/or unrelated to the first condition) without assigning a value to the first condition. As such, each content provider need not assign values to every condition. For example, the first content provider assigns a value to a weather condition (e.g., sunny) and the second content provider assigns a value to detection of a particular object (e.g., a diaper company assigns a value to detection of a stroller within the proximity of the EVCS), without assigning a value to the weather conditions. In some embodiments, the server 120 takes into account every content provider that has provided values to any of the conditions that are currently satisfied by the EVCS. For example, if it is both sunny and a stroller is detected within the proximity of the EVCS, the server 120 will compare the values assigned by the first content provider and the second content provider (e.g., and select the content for the content provider that has assigned the greatest value under the current conditions).

In some embodiments, the server 120 provides media content 718 to EVCS 100. In some embodiments, the media content is provided for display by the EVCS 100 (e.g., on display 210). In some embodiments, the media content is provided for display by a user device 112.

In some embodiments, the server 120 optionally provides a report (720) to the respective content provider associated with the media content item that is selected.

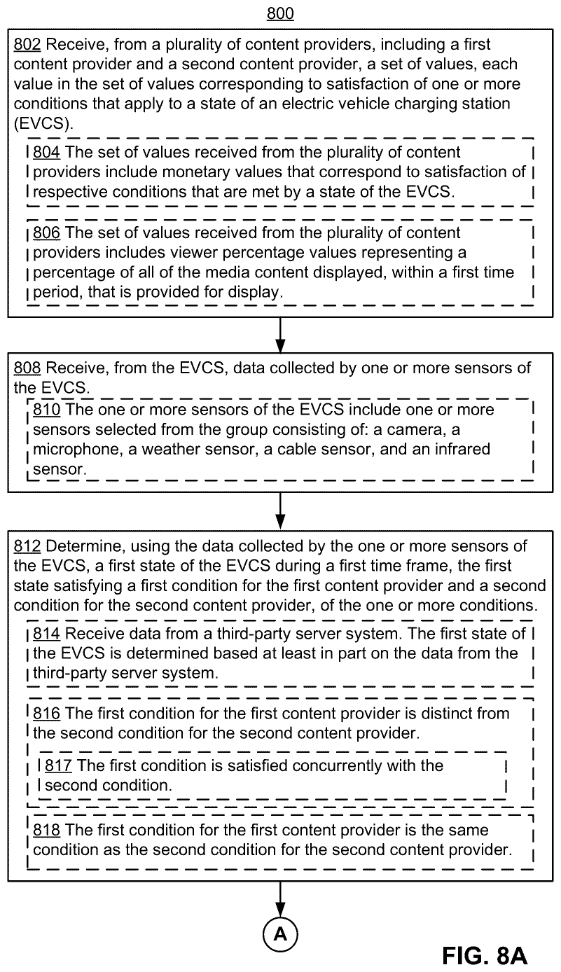

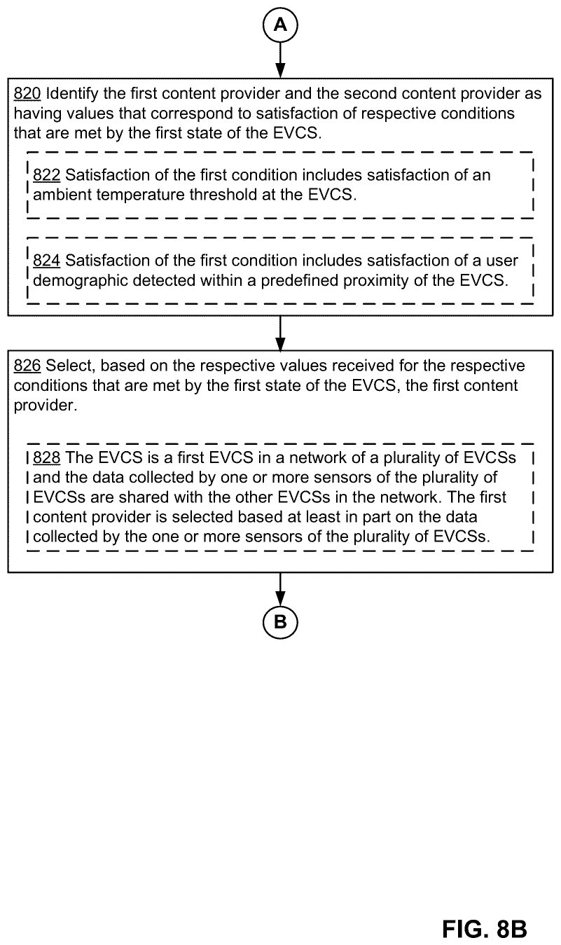

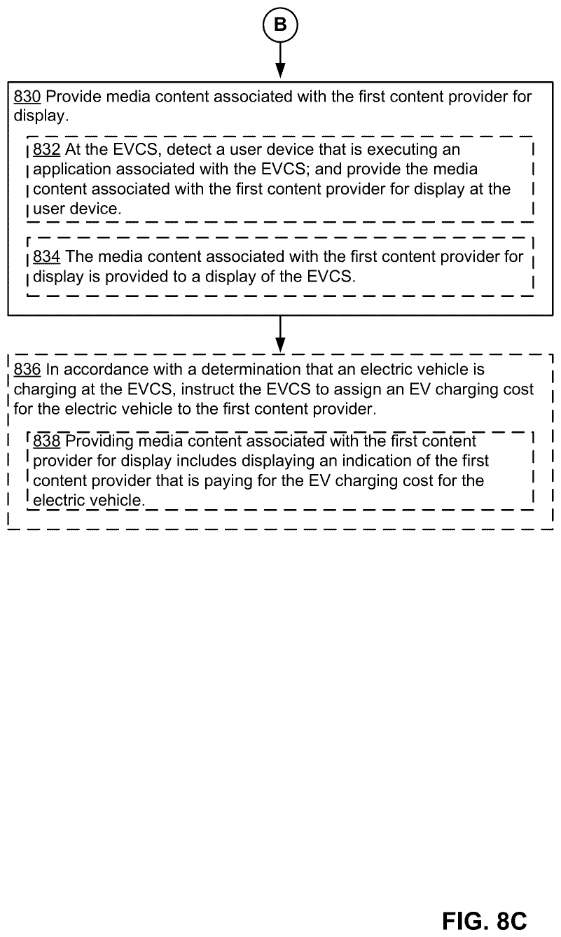

FIGS. 8A-8C illustrate a flowchart of a method 800 of selecting media content to provide based on sensor data received from an EVCS. The method 800 is performed at a server system with one or more processors and memory (e.g., server system 120, FIG. 2), the server system being in communication with an EVCS.

The method 800 comprises receiving (802), from a plurality of content providers, including a first content provider and a second content provider, a set of values (e.g., bids), each value in the set of values corresponding to satisfaction of one or more conditions that apply to a state of an electric vehicle charging station (EVCS). For example, a content provider (e.g., a company) sets a first monetary value for when a first condition is met (e.g., weather is above X temperature) and sets a second monetary value for when two or more conditions are met (e.g., time of day is between Y-Z and day of week is Saturday).

In some embodiments, the set of values received from the plurality of content providers includes (804) monetary values that correspond to the satisfaction of one or more conditions that apply to the state of the EVCS.

In some embodiments, the set of values received from the plurality of content providers includes (806) viewer percentage values representing a percentage of all of the media content displayed, within a first time period, that is provided for display (e.g., a first content provider assigns a greater value to be displayed 25% of the time, whereas if the first content provider is not displayed 25% of the time, the first content provider is not willing to assign as great of a value).

The method includes receiving (808), from the EVCS, data collected by one or more sensors of the EVCS.

In some embodiments, wherein the one or more sensors of the EVCS include (810) one or more sensors selected from the group consisting of: a camera, a microphone, a weather sensor, a cable sensor, and an infrared sensor. In some embodiments, the one or more sensors of the EVCS 100 include one or more image (e.g., optical) sensors (e.g., one or more cameras 206), ultrasound sensors, depth sensors, infrared (IR), red-green-blue (RGB) cameras, passive infrared (PIR), heat IR, proximity sensors, radar, and/or tension sensors.

The method includes determining (812), using the data collected by the one or more sensors of the EVCS, a first state of the EVCS during a first time frame, the first state satisfying a first condition for the first content provider and a second condition for the second content provider, of the one or more conditions (e.g., the first time frame is a current time frame).

In some embodiments, the instructions further include instructions for receiving (814) data from a third-party server system, and the first state of the EVCS is determined based at least in part on the data from the third-party server system (e.g., external weather reports (e.g., from third-party servers) are imported to the server 120). In some embodiments, the received data (e.g., that is not detected by the sensors of the EVCS) are received via an API call. In some embodiments, the state of the EVCS is determined based on a combination of the data collected by the one or more sensors of the EVCS and the received data from the API call(s).

In some embodiments, the first condition for the first content provider is (816) distinct from the second condition for the second content provider.

In some embodiments, the first condition is satisfied (817) concurrently with the second condition. For example, two or more conditions occur at the same time (e.g., weather and day of the week, etc.).

In some embodiments, the first condition for the first content provider is (818) the same condition as the second condition for the second content provider. For example, both the first content provider and the second content provider assign values to a same condition (e.g., the first content provider assigns the first value to a temperature above a certain degree, and the second content provider assigns the second value to the temperature above the certain degree).

The method includes identifying (820) the first content provider and the second content provider as having values that correspond to satisfaction of the respective conditions that are met by the first state of the EVCS. For example, the server 120 executes a bidding protocol, as described with reference to FIGS. 6 and 7, based on the detected environmental conditions. In some embodiments, identifying the two or more content providers comprises identifying two or more content items (e.g., having the greatest values assigned, as described with reference to FIG. 6), each content item associated with a content provider.

In some embodiments, satisfaction of the first condition includes (822) satisfaction of an ambient temperature threshold at the EVCS (e.g., or another weather event (e.g., rain, snow, sun, clouds, etc.)). In some embodiments, the one or more conditions includes a geographic location of the EVCS and/or a proximity to a predefined business type (e.g., an EVCS close to a mall versus a grocery store versus a coffee shop).

In some embodiments, satisfaction of the first condition includes (824) satisfaction of a user demographic detected within a predefined proximity of the EVCS. For example, the one or more sensors detect one or more individuals and/or objects near the EVCS (e.g., detectable by one or more cameras or other sensors of the EVCS) and/or the one or more sensors detect one or more user devices near the EVCS. In some embodiments, content providers assign values to demographics (e.g., age, gender, physical features (e.g., beard, hair color) information collected using the one or more sensors, or other profile information available from the user devices (e.g., profile information from a mobile application executing on the user devices)) of the individuals detected near the EVCS (e.g., a first value is assigned to an estimated age range of a detected individual, a second value is assigned based on a number of individuals detected near the EVCS). In some embodiments, content providers assign values to the detection of various objects (e.g., a vehicle type, a stroller, etc.).

The method includes selecting (826), based on values for the respective conditions that are met by the first state of the EVCS, the first content provider. In some embodiments, selecting the content provider based on the respective values comprises selecting a content item, and identifying a content provider associated with the selected content item.

It should be understood that any manner of selection algorithm (e.g., bid selection algorithm) may be used to perform the selection. In some circumstances, the highest bidder is not necessarily selected. For example, in addition to the values, other incentives and requirements for content selection may be considered (for example, a requirement to display a certain content provider's content at least 10% of the time, or an incentive to display a certain content provider's content at least 25% of the time). In such circumstances, the method may include assigning weights/values to incentives and/or testing the selected content item against the requirements (such that a selected content item will fail if it fails to meet the requirements, resulting in the method starting over).

In some embodiments, the EVCS is (828) a first EVCS in a network of a plurality of EVCSs and the data collected by one or more sensors of the plurality of EVCSs are shared with the other EVCSs in the network. In some embodiments, the first content provider is selected based at least in part on the data collected by the one or more sensors of the plurality of EVCSs. For example, as described with reference to FIG. 6, sensor data received from a first EVCS is used to select content to provide to a second EVCS, distinct from the first EVCS, in the network.

The method includes providing (830) media content associated with the first content provider for display. In some embodiments, the media content is provided to the EVCS and/or to the user's mobile phone (e.g., user device 112). In some embodiments, the method includes performing additional actions other than providing media content, such as paying for the user's charge. For example, a content provider is enabled to provide instructions for, under the current conditions, granting permission to charge the content provider for a user's charge of the user's vehicle using the EVCS (e.g., such that the content provider pays for the user's charge), and instructions for providing media content (e.g., to the user's phone and/or to the display of the EVCS) that indicates that the content provider is paying for the user's charge.

In some embodiments, the method includes, at the EVCS, detecting (832) a user device that is executing an application associated with the EVCS and providing the media content associated with the first content provider for display at the user device (e.g., in conjunction with and/or instead of displaying on the EVCS). In some embodiments, the server 120 identified a user associated with the user device that is detected near (e.g., within a predefined proximity of) the EVCS, and the server 120 receives (e.g., or retrieves) demographic data associated with the user identified by the user device. In some embodiments, satisfaction of the respective conditions includes detection of an individual (e.g., the user) having particular demographic characteristics. In some embodiments, providing content to the user device comprises providing a coupon or other loyalty incentive (e.g., from the first content provider).

In some embodiments, the media content associated with the first content provider for display is provided (834) to a display of the EVCS. In some embodiments, the media content is a video, an image, an advertisement and/or a coupon.

In some embodiments, the method includes, in accordance with a determination that an electric vehicle is charging at the EVCS, instructing (836) the EVCS to assign an EV charging cost for the electric vehicle to the first content provider. In some embodiments, providing (838) media content associated with the first content provider for display includes displaying an indication of the selected content provider that is paying for the EV charging cost for the electric vehicle.

It will be understood that, although the terms first, second, etc., are, in some instances, used herein to describe various elements, these elements should not be limited by these terms. These terms are only used to distinguish one element from another. For example, a first identifier could be termed a second identifier, and, similarly, a second identifier could be termed a first identifier, without departing from the scope of the various described implementations. The first identifier and the second identifier are both identifiers, but they are not the same identifiers unless explicitly stated as such.

The terminology used in the description of the various described implementations herein is for the purpose of describing particular implementations only and is not intended to be limiting. As used in the description of the various described implementations and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The foregoing description, for purpose of explanation, has been described with reference to specific implementations. However, the illustrative discussions above are not intended to be exhaustive or to limit the scope of the claims to the precise forms disclosed. Many modifications and variations are possible in view of the above teachings. The implementations were chosen in order to best explain the principles underlying the claims and their practical applications, to thereby enable others skilled in the art to best use the implementations with various modifications as are suited to the particular uses contemplated.

What is claimed is:

1. A system, comprising:
a server that is in communication with an electric vehicle charging station (EVCS), the server comprising one or more processors and memory storing instructions executable by the one or more processors for:
receiving, from a plurality of content providers, including a first content provider and a second content provider, a set of values, each value in the set of values corresponding to satisfaction of one or more conditions that apply to a state of an electric vehicle charging station (EVCS);
receiving, from the EVCS, data collected by one or more sensors of the EVCS;
determining, using the data collected by the one or more sensors of the EVCS, a first state of the EVCS during a first time frame, the first state satisfying a first condition for the first content provider and a second condition for the second content provider, of the one or more conditions;
identifying the first content provider and the second content provider as having values that correspond to satisfaction of respective conditions that are met by the first state of the EVCS;
selecting, based on values received for the respective conditions that are met by the first state of the EVCS, the first content provider; and
providing media content associated with the first content provider for display.

2. The system of claim 1, wherein the first condition for the first content provider is distinct from the second condition for the second content provider.

3. The system of claim 2, wherein the first condition is satisfied concurrently with the second condition.

4. The system of claim 1, wherein the first condition for the first content provider is the same condition as the second condition for the second content provider.

5. The system of claim 1, wherein the instructions further include instructions for:
at the EVCS, detecting a user device that is executing an application associated with the EVCS; and
providing the media content associated with the first content provider for display at the user device.

6. The system of claim 1, wherein the media content associated with the first content provider for display is provided to a display of the EVCS.

7. The system of claim 1, wherein the set of values received from the plurality of content providers include monetary values that correspond to satisfaction of respective conditions that are met by a state of the EVCS.

8. The system of claim 1, wherein the set of values received from the plurality of content providers includes viewer percentage values representing a percentage of all of the media content displayed, within a first time period, that is provided for display.

9. The system of claim 1, wherein:
the EVCS is a first EVCS in a network of a plurality of EVCSs;
the data collected by one or more sensors of the plurality of EVCSs are shared with the other EVCSs in the network; and
the first content provider is selected based at least in part on the data collected by the one or more sensors of the plurality of EVCSs.

10. The system of claim 1, wherein the instructions further include instructions for, in accordance with a determination that an electric vehicle is charging at the EVCS, instructing the EVCS to assign an EV charging cost for the electric vehicle to the first content provider.

11. The system of claim 10, wherein providing media content associated with the first content provider for display includes displaying an indication of the first content provider that is paying for the EV charging cost for the electric vehicle.

12. The system of claim 1, wherein the one or more sensors of the EVCS include one or more sensors selected from the group consisting of: a camera, a microphone, a weather sensor, a cable sensor, and an infrared sensor.

13. The system of claim 1, wherein satisfaction of the first condition includes satisfaction of an ambient temperature threshold at the EVCS.

14. The system of claim 1, wherein satisfaction of the first condition includes satisfaction of a user demographic detected within a predefined proximity of the EVCS.

15. The system of claim 1, wherein the instructions further include instructions for receiving data from a third-party server system, and the first state of the EVCS is determined based at least in part on the data from the third-party server system.

16. A method, comprising:
at a server that is in communication with an electric vehicle charging station (EVCS), the server including one or more processors and memory storing instructions executable by the one or more processors:
receiving, from a plurality of content providers, including a first content provider and a second content provider, a set of values, each value in the set of values corresponding to satisfaction of one or more conditions that apply to a state of an electric vehicle charging station (EVCS);
receiving, from the EVCS, data collected by one or more sensors of the EVCS;
determining, using the data collected by the one or more sensors of the EVCS, a first state of the EVCS during a first time frame, the first state satisfying a first condition for the first content provider and a second condition for the second content provider, of the one or more conditions;
identifying the first content provider and the second content provider as having values that correspond to satisfaction of respective conditions that are met by the first state of the EVCS;
selecting, based on values received for the respective conditions that are met by the first state of the EVCS, the first content provider; and
providing media content associated with the first content provider for display.

17. A non-transitory computer readable storage medium storing instructions, which, when executed by a system that includes one or more processors, causes the one or more processors to perform a set of operations, comprising:
receiving, from a plurality of content providers, including a first content provider and a second content provider, a set of values, each value in the set of values corresponding to satisfaction of one or more conditions that apply to a state of an electric vehicle charging station (EVCS);
receiving, from the EVCS, data collected by one or more sensors of the EVCS;
determining, using the data collected by the one or more sensors of the EVCS, a first state of the EVCS during a first time frame, the first state satisfying a first condition for the first content provider and a second condition for the second content provider, of the one or more conditions;
identifying the first content provider and the second content provider as having values that correspond to satisfaction of respective conditions that are met by the first state of the EVCS;
selecting, based on values received for the respective conditions that are met by the first state of the EVCS, the first content provider; and
providing media content associated with the first content provider for display.
